(19) United States
(12) Patent Application Publication
(10) Pub. No.: US 2008/0059326 A1
(43) Pub. Date: Mar. 6, 2008

(54) Document issuance system

(75) Inventors: Yasuo Sugahara, Kawasaki (JP); Hiroyuki Sato, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/654,016

(22) Filed: Jan. 17, 2007

(30) Foreign Application Priority Data
Sep. 6, 2006 (JP) JP2006-241739

(51) Int. Cl. G06Q 30/00

(52) U.S. Cl. 705/26

(57) ABSTRACT

The present invention relates to a document issuance system capable of making efficient a receipt-and-invoice issuance management operation for an ordered merchandise. The document issuance system comprises an accepting unit accepting an issuance request related to at least one document of a receipt and an invoice inputted from a terminal, a retaining unit retaining information about the issuance request accepted by the accepting unit as being related to the order information of a merchandise being the subject of the issuance-requested document, a checking unit checking a state of issuance of the issuance-requested documents based on the issuance request information and the order information that are retained by the retaining unit, and a generating unit generating a list screen displaying the states of issuance of the respective documents, which are checked by the checking unit, in the form of a list on a predetermined terminal.

### BACKGROUND OF THE INVENTION

1. Field of the Invention

The present invention relates to a document issuance system that manages issuance of a receipt and an invoice of a merchandise ordered by utilizing online shopping etc.

2. Description of the Related Art

Consumers can purchase a variety of merchandise such as personal computers by utilizing online shopping services provided on a network such as the Internet. The consumer orders a desired merchandise by accessing an online shopping Web site provided by a server connected to the Internet from on a terminal connectable to the Internet. At this time, the consumer selects a payment method of a charge for purchasing the merchandise etc from on a screen on the online shopping Web site. Thereafter, a manufacturer company of the merchandise is notified of order information managed by the server via the Internet, and the ordered merchandise is delivered to the consumer from the manufacturer company.

The consumer, in the case of purchasing the merchandise by utilizing this type of online shopping service and desiring the issuance of the receipt and the invoice, separately requests a predetermined inquiry counter by phone, e-mail, etc. Generally, a member of operation staff at the inquiry counter, in response to this request, enters information in a receipt application form or an invoice application form, and transfers the application form to a person-in-charge at a finance division, who is in charge of an operation of approving and formally issuing the receipt and the invoice, thereby managing the issuance of the receipt or the invoice requested and managing the forwarding of the receipt or the invoice to a requester.

The invoice and the receipt can not, however, be issued immediately upon receiving the request. In particular, the receipt is issued after the ordered merchandise has been delivered to the consumer and the charge thereof has been paid by the consumer.

Accordingly, the receipt-and-invoice issuance management operation by the member of operation staff involves searching for the merchandise serving as a basis of the receipt and the invoice from the order information, and requiring an operation of observing every state of manufacturing the ordered merchandise etc, resulting in an inefficient operation.

A technology disclosed in the following Patent document 1 is given as a related technology for solving such a problem. The following Patent document 1 discloses the technology by which a communication-enabled connection between a printing apparatus of a customer and a maintenance management company is established via a public line, and an order of a consumption article of the printing apparatus is readily given to the maintenance management company from on the printing apparatus. The Patent document 1 is “Japanese Patent Application Laid-Open Publication No. 2002-244506.”

The technology disclosed in the Patent document 1 is, however, utilizable with respect to only the consumption article employed by the already-purchased printing apparatus, i.e., the merchandise about which customer information such as a transaction type can be grasped beforehand by the maintenance management company. The technology disclosed in the Patent document 1 can not be applied directly to the shopping services that deal with the merchandise such as the personal computers, which are broadly demanded by the general consumers.

### SUMMARY OF THE INVENTION

It is an object of the present invention to provide a document issuance system capable of making efficient the receipt-and-invoice issuance management operation of the ordered merchandise.

The present invention adopts the following configurations in order to solve the above mentioned problems. Namely, the present invention is related to a document issuance system comprising an accepting unit accepting an issuance request related to at least one document of a receipt and an invoice inputted from a terminal, a retaining unit retaining information about the issuance request accepted by the accepting unit as being related to order information of a merchandise that is the subject of the issuance-requested document, a checking unit checking a state of issuance of each of the issuance-requested documents on the basis of the issuance request information and the order information that are retained by the retaining unit, and a generating unit generating a list screen displaying the states of issuance of the respective issuance-requested documents, which are checked by the checking unit, in the form of a list on a predetermined terminal.

According to the present invention, the information about the issuance request related to at least one document of the receipt and the invoice and the order information of the merchandise serving as the basis of the issuance-requested document, are retained in a way that associates these items of information with each other, and the list screen, on which to display a list of the issuance states checked with respect to the respective documents, is generated based on these retained items of information.

With this configuration, according to the present invention, the check of the requested receipt-and-invoice issuance states involves utilizing the order information retained with respect to the merchandise serving as the basis thereof. Then, the receipt-and-invoice issuance states can be grasped simply by referring to this list screen, and it is therefore possible to make efficient the receipt-and-invoice issuance management operation of the ordered merchandise.

Further, the document issuance system according to the present invention further comprise an output unit outputting respective data files enabling operation documents necessary for issuing the respective issuance-requested documents to be printed.

According to this configuration, the operation documents necessary for issuing the receipt and the invoice can be printed based on the data files outputted by the output unit, and hence the invoice-and-receipt issuance operation can be made efficient.

Still further, the generating unit may exclude, from on the list screen, the document that has already been outputted by the output unit.

According to this contrivance, the already-issued document can be easily distinguished.

Yet further, the accepting unit may include a request screen generating unit generating an issuance request screen on which the terminal inputs the issuance request, and a request screen control unit controlling the issuance request screen generated by the request screen generating unit on the basis of the order information of merchandise that is the subject of the issuance-requested document, and displaying the controlled issuance request screen on the terminal.

The request screen control unit controls the issuance request screen so that only one of the invoice and the receipt can be issuance-requested corresponding to, e.g., a payment method of the merchandise that is contained in the order information of the merchandise.

With this contrivance, it is possible to prevent a mis-input of a user who inputs the issuance request by use of the terminal.

Moreover, the accepting unit may further include an identifying unit identifying a user who employs the terminal, and the request screen control unit may control as to whether the issuance request screen can be displayed or not, corresponding to the user identified by the identifying unit.

With this configuration, for example, the issuance request screen can be schemed not to be displayed on the terminals employed by the general users such as the consumers but to be displayed on the terminal employed by an agent in charge of a purchase consulting counter.

Furthermore, the generating unit may include an identifying unit identifying a user who employs the predetermined terminal, and a list screen control unit controlling as to whether the list screen can be displayed or not, corresponding to the user identified by the identifying unit.

This contrivance enables the list screen to be displayed on only the terminal used by the user who conducts the document issuance management operation.

Additionally, the document issuance system according to the present invention may be configured in the form of including an online shopping server opened on a public network and a manufacturer server administered by a manufacturer company of the merchandise ordered by the online shopping server, the accepting unit may be provided in each of online shopping server and the manufacturer server, the retaining unit, the checking unit and the generating unit may be provided in the manufacturer server, and the order information may contain information about the order acquired by the online shopping server.

According to this configuration, the order information can be obtained as the information about the merchandise ordered on the online shopping, and it follows that the order information can be utilized also for accepting the issuance request.

It should be noted that the present invention can be actualized also as a document issuance method, a program making an information processing device (computer) function as the document issuance system, or a readable-by-computer storage medium recorded with the program, which have the same features as those of the document issuance system according to the present invention.

According to the present invention, it is possible to actualize the document issuance system that makes efficient the invoice-and-receipt issuance management operation of the ordered merchandise.

### BRIEF DESCRIPTION OF THE DRAWINGS

FIG. 1 is a diagram showing an example of a system architecture of an integrated online shopping system;

FIG. 2 is a diagram showing an example of a functional configuration of an order receiving server;

FIG. 3 is a diagram showing items of information stored in an issuance document interface file;

FIG. 4 is a diagram showing an example of a functional configuration of an order management server;

FIG. 5 is a diagram showing an order information table;

FIG. 6 is a diagram showing a receipt information table;

FIG. 7 is a diagram showing an invoice information table;

FIG. 8 is a diagram showing a concept of a processing flow of an online shopping system;

FIG. 9 is a diagram showing a concept of a processing flow of the online shopping system and a document issuance system;

FIG. 10 is a diagram showing an example of an order completion screen;

FIG. 11 is a diagram showing an example of an issuance request screen;

FIG. 12 is a diagram showing a display control table on the issuance request screen;

FIG. 13 is a diagram showing a concept of a processing flow of the document issuance system of the order management server;

FIG. 14 is a diagram showing an example of the issuance request screen;

FIG. 15 is a diagram showing an example of a wait-for-issuance list screen;

FIG. 16 is a diagram showing and example of a receipt modifying screen;

FIG. 17 is a diagram showing and example of an invoice modifying screen; and

FIG. 18 is a diagram showing an example of an already-issued list screen.

### DESCRIPTION OF THE PREFERRED EMBODIMENTS

### Embodiment

An invoice-and-receipt issuance system (which will hereinafter be simply referred to as a document issuance system) in an embodiment of the present invention will hereinafter be described with reference to the drawings. The document issuance system in the present embodiment issues an invoice and a receipt of a merchandise marketed on an online shopping system by linking with this online shopping system (wherein only the invoice or only the receipt can be issued). In the following description, a system, which integrates this online shopping system with the document issuance system according to the present embodiment, shall be called an integrated online shopping system. A configuration in the following embodiment is an exemplification, and the present invention is not limited to the configuration in the embodiment.

[System Architecture]

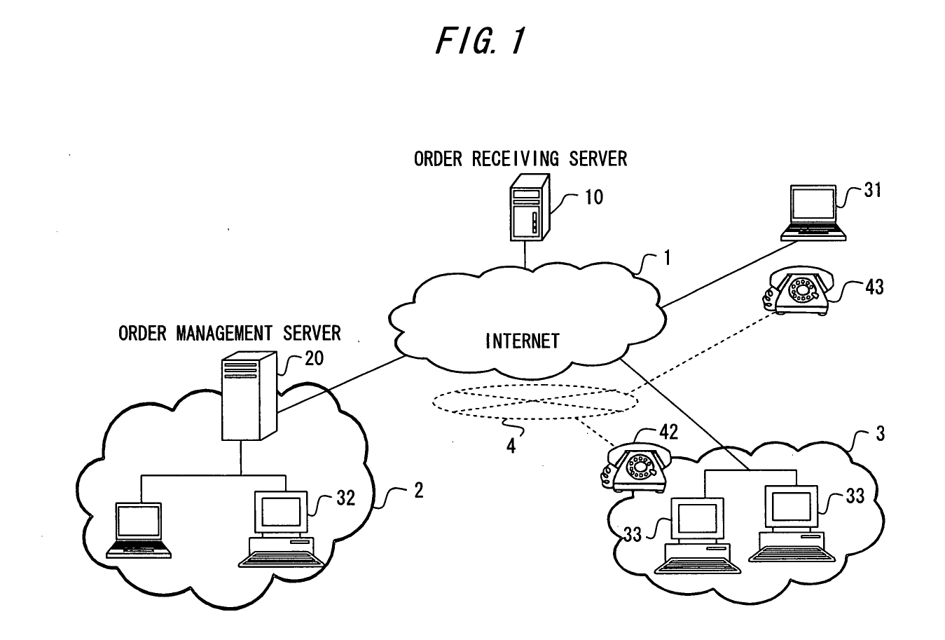

FIG. 1 is a view showing a system architecture of the integrated online shopping system. The system architecture of the integrated online shopping system illustrated in FIG. 1 is applied directly to a system architecture of the document issuance system in the present embodiment. The system architecture of the integrated online shopping system will hereinafter be explained with reference to FIG. 1.

The integrated online shopping system is configured by connecting an order receiving server 10, an order management server 20, an agent terminal 33, a staff terminal 32, etc to each other via a network. The network is configured by connecting, respectively to the Internet 1, an company intranet 2 of a company as a manufacturer of merchandise put on the market through the online shopping system and an agent network 3 of an agent that conducts by proxy a customer consultation service of the merchandise thereof. The order receiving server 10 is connected to the Internet 1, the order management server 20 and the staff terminal 32 are connected to the company intranet 2, and the agent terminal 33 is connected to the agent network 3. The Internet 1 corresponds to a public network according to the present invention.

A consumer purchases the merchandise by utilizing the online shopping system and can therefore take two methods. One method is a method of accessing directly an online shopping Web site provided by the order receiving server 10 in a way that operates a user terminal 31 having an Internet connecting function, such as a mobile phone and a personal computer. Another method is a method of giving an order by phone to a merchandise purchase consulting counter of which the agent is in charge. The latter method is that a person-in-charge belonging to the agent receiving this order by phone operates the agent terminal 33, thereby accessing the online shopping Web site and executing the order. In this case, the order by phone is made in a way that dials a telephone 42 of the agent by using a telephone 43 connected to a public line 4 etc.

Further, the consumer can make a request for issuing a receipt and an invoice of the merchandise purchased via the online shopping system by utilizing the document issuance system in the present embodiment. The consumer may take two methods of requesting the issuance of the receipt and the invoice. One requesting method is a method of requesting the simultaneous issuance of the receipt and the invoice when giving the via-phone order of the merchandise to the agent as by the latter method described above. Another requesting method is a method of requesting, after accessing directly the online shopping Web site and ordering the merchandise as by the former method described above, the issuance of the receipt and the invoice by e-mailing the operation counter of the manufacturer company of the merchandise or by telephoning the agent.

[Configurations of Devices]

Next, each of the devices configuring the integrated online shopping system will be explained.

<Order Receiving Server>

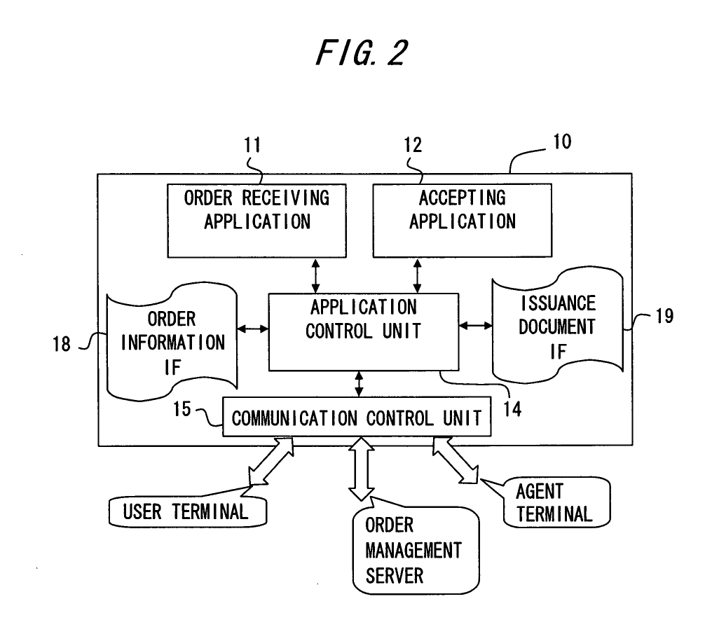

FIG. 2 is a block diagram showing an example of a functional configuration of the order receiving server 10. A device configuration of the order receiving server 10 will hereinafter be described with reference to FIG. 2.

The order receiving server 10 includes, as a hardware configuration, a CPU (Central Processing Unit), a memory, an input/output interface, etc. The order receiving server 10 may be constructed of a general-purpose computer such as a personal computer, and may also be constructed of a dedicated computer. The present invention does not limit this type of hardware configuration of the order receiving server 10. The order receiving server 10, for example, with the CPU reading and executing application programs stored in the memory etc, thereby actualizes the respective function units shown in FIG. 2.

The order receiving server 10 has an order receiving application 11, an accepting application 12, an application control unit 14, a communication control unit 15, an order information interface file 18, an issuance document interface file 19, etc.

The communication control unit 15 controls a network interface etc for connecting the order receiving server 10 to the Internet 1. The communication control unit 15 controls the communications transmitted and received between the order receiving server 10 and the user terminal 31, the order management server 20 and the agent terminal 33. The communication control unit 15 receives an instruction from the application control unit 14, then transmits a necessary item of data, and transfers the received data to the application control unit 14.

The application control unit 14 controls respectively the order receiving application 11 and the accepting application 12 that actualize the integrated online shopping system. If these applications are built up as Web applications (including Java (registered trademark) application), the application control unit 14 has a Web server function (including Java (registered trademark) virtual machine etc). Further, if these applications are built up as dedicated applications other than those described above, the application control unit 14 has a process management function etc thereof.

Moreover, the application control unit 14 conducts management as to whether the user utilizing the integrated online shopping system is a general consumer or an agent. The application control unit 14 gets, e.g., a log-in screen etc displayed on the terminal of the user, and judges user identifying information etc inputted from on the screen, thereby management the user. The application control unit 14, if the user is judged to be the consumer, controls the accepting application 12 not to operate.

The order receiving application 11 provides the online shopping service to the user terminal 31 and to the agent terminal 33. In other words, the order receiving application 11 actualizes the online shopping system. The order receiving application 11 shall be built up as the Web application in the present embodiment. Hence, the order receiving application 11 is built up by an HTML (HyperText Markup Language) file, an image file, a Java (registered trademark) program etc, which configure a predetermined screen. The present invention does not limit the method of building up this order receiving application 11, and the order receiving application 11 may be built up as a dedicated application. Note that an in-depth description of the screen provided so as to be displayed on the display unit of the user terminal 31 and on the display unit of the agent terminal 33, will be given in the paragraph of [Operational Example].

The accepting application 12 provides the agent terminal 33 with a receipt-and-invoice issuance service (which will hereinafter be referred to also as a document issuance service). In other words, the accepting application 12 actualizes a consumer- and agent-oriented function of the document issuance system in the present embodiment.

A method of building up the accepting application 12 is not restricted by the present invention similarly to the order receiving application 11 described above. An assumption in the present embodiment is that the accepting application 12 is built up as the Web application.

The accepting application 12, upon completion of an order of the merchandise with the execution of the order receiving application 11, is thereafter executed. The accepting application 12 is not, however, in the case of the user being judged to be the consumer, executed under the control of the application control unit 14. Further, if the issuance of the receipt etc is not requested though ordered by phone, the accepting application 12 is not executed. Note that details of the screen provided to the agent terminal 33 by the accepting application 12 will be explained in the paragraph of [Operational Example].

The order information interface file 18 is generated when the order receiving application 11 completes the order, and stores respective items of information on each of the orders. The order information interface file 18 stores items of information such as an order number, a name of customer, a name of merchandise, a model number of merchandise, number of merchandise, a delivery destination and a payment method. Among these items of information, the order number is a unique identifying number assigned to each order in order to identify every order. The order number is assigned by, e.g., the order receiving application 11. The order information interface file 18 is collected by the order management server 20.

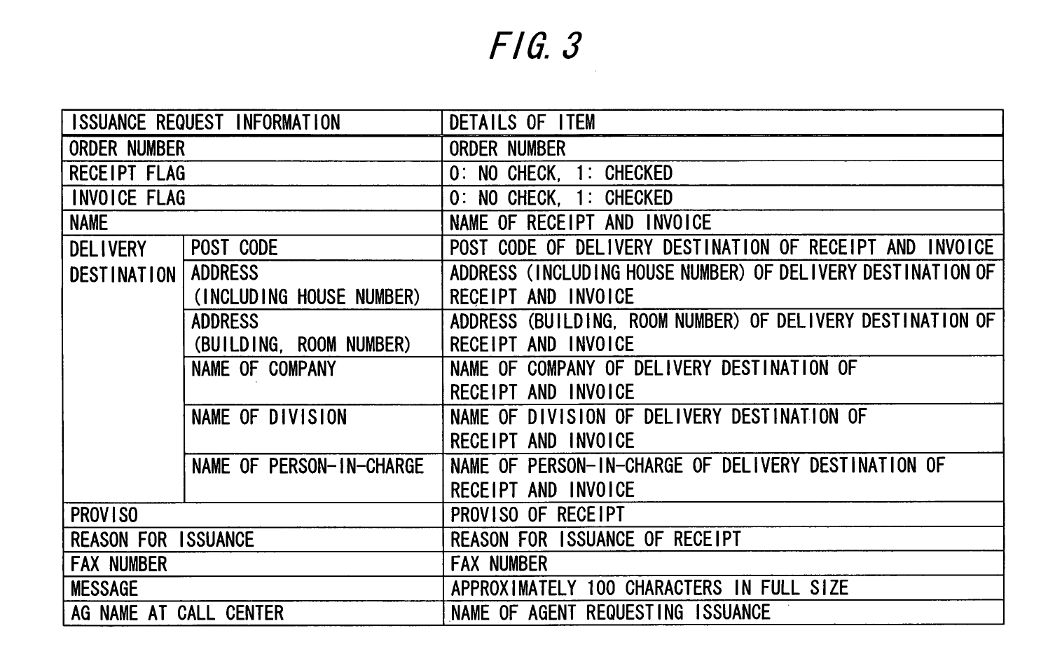

The issuance document interface file 19 is generated when the accepting application 12 completes the receipt-and-invoice issuance request, and stores items of information on every document issuance request. FIG. 3 is a diagram showing the information stored in the issuance document interface file 19. As shown in FIG. 3, the issuance document interface file 19 stores an order number, a receipt flag, an invoice flag, a name, a delivery destination (a post code, an address, a name of company, etc), a proviso, a reason for issuance, a FAX number, a message, a call center agent name, etc.

The order number stored in the issuance document interface file 19 is assigned to the receipt etc issuance target order. The accepting application 12 accepting the receipt-and-invoice issuance request operates in linkage with the order receiving application 11, and therefore the order numbers assigned by the order receiving application 11 are used as they are.

When requested to issue a receipt of the target order, [1] is set in the receipt flag. When requested to issue an invoice of the target order, [1] is set in the invoice flag. Moreover, the messages given from the agent serving as the purchase consulting counter accepting the request by phone to operation staff of a company as a manufacturer of the merchandise, are set in the field of the message. A name of person-in-charge at the agent is stored in the field of the call center agent name.

<Order Management Server>

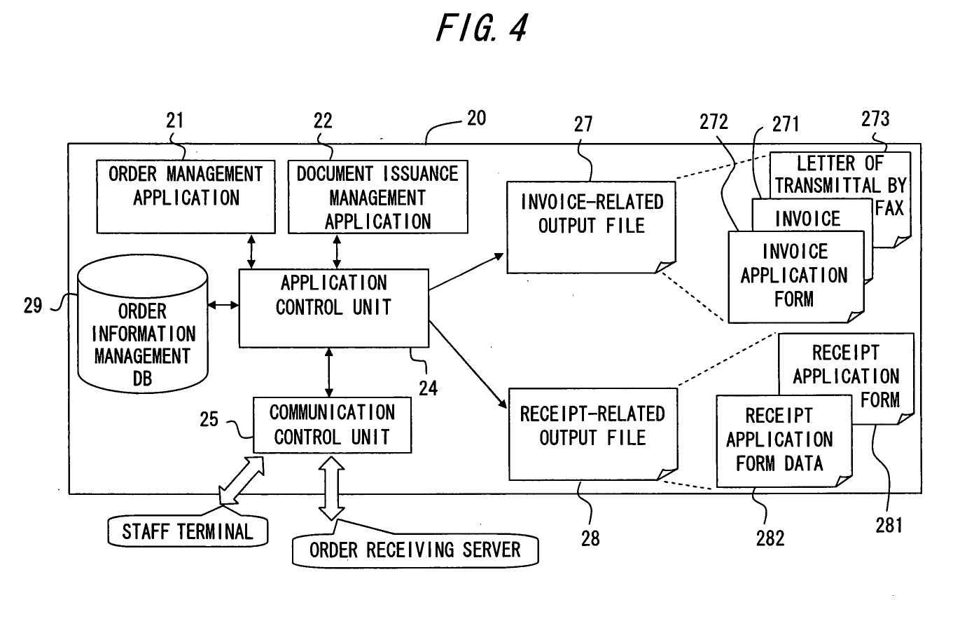

FIG. 4 is a block diagram showing an example of a functional configuration of the order management server 20. A device configuration of the order management server 20 will hereinafter be described with reference to FIG. 4.

The order management server 20 includes, as a hardware configuration, a CPU, a memory, an input/output interface, etc. The order management server 20 may be constructed of a general-purpose computer such as a personal computer, and may also be constructed of a dedicated computer. The present invention does not limit this type of hardware configuration of the order management server 20. The order management server 20, for example, with the CPU reading and executing application programs stored in the memory etc, thereby actualizes the respective function units illustrated in FIG. 4.

The order management server 20 has an order management application 21, a document issuance management application 22, an application control unit 24, a communication control unit 25, an order information management database 29, etc.

The communication control unit 25 controls a network interface etc for connecting the order management server 20 to the company intranet 2. The communication control unit 25 controls the communications transmitted and received between the order receiving server 10 and the order management server 20. The communication control unit 25 receives an instruction from the application control unit 24, then transmits a necessary item of data, and transfers the received data to the application control unit 24. It is to be noted that if the order management server 20 is situated as a gateway establishing a connection between the company intranet 2 and the Internet 1, the communication control unit 25 may have the gateway function. The control is, however, done to disable an access to the order management server 20 from the user terminal 31 utilized by the general consumer and from the agent terminal 33 utilized by the agent.

The application control unit 24 controls the order management application 21 and the document issuance management application 22. If these applications are built up as Web applications (including Java (registered trademark) application), the application control unit 24 has a Web server function (including Java (registered trademark) virtual machine etc). Further, if these applications are built up as dedicated applications other than those described above, the application control unit 24 has a process management function etc thereof.

Normally, the order management server 20 is a server utilized only by the operation staff of the manufacturer company of the merchandise, however, the application control unit 24 may have a management function for identifying as to whether the user utilizing the order management server 20 is a member of the operation staff thereof or not.

The order management application 21 manages the order of the merchandise and the document issuance request, which are accepted by the order receiving application 11 and the accepting application 12 of the order receiving server 10. To be specific, the order management application 21 periodically collects the order information interface file 18 and the issuance document interface file 19 of the order receiving server 10 respectively, and stores the collected information in the order information management database 29.

Further, the order management application 21 links up with another company system (e.g., an arrangement system (unillustrated) utilized by a manufacturing line etc). For instance, the collected items of order information are transmitted to the arrangement system, and conversely delivery date information etc of the ordered merchandise is received from the arrangement system. It should be noted that the present invention does not limit the method of building up the order management application 21, and the order management application 21 may also be built up as a dedicated application.

The document issuance management application 22 actualizes an operation staff oriented function of the document issuance system in the present embodiment. Namely, the document issuance management application 22 provides receipt-and-invoice issuance management services to the staff terminals 32 used by the operation staff of the manufacturer company of the merchandise. The management services provided by the document issuance management application 22 are categorized into a service (a first management service) utilized when the member of operation staff accepts the receipt-and-invoice issuance request, a service (a second management service) for managing a state of the receipt-and-invoice issuance requested, and a service (a third management service) for reissuing the document which is to be modified about a requested content or has already been issued.

The first management service is that when an operation counter of the manufacturer company is requested to issue the receipt and the invoice by e-mail after the consumer has ordered the merchandise, the staff terminal 32 employed by the member of operation staff is provided with a screen for registering the receipt-and-invoice issuance request. Further, when the agent is requested to issue the receipt and the invoice by phone after the consumer has ordered the merchandise, the member of operation staff utilizes the first management service through notification given from the agent.

The second management service provides the staff terminal 32 with an issuance waiting list screen of a requested receipt-and-invoice, wherein an invoice-related output file 27 and a receipt-related output file 28 about each requested order are outputted from on this screen. The invoice-related output file 27 and the receipt-related output file 28 are outputted as electronic files.

The invoice-related output file 27 contains invoice format data 271, invoice application form format data 272 and FAX letter-of-transmittal format data 273. The respective items of format data 271, 272 and 273 are printed as an invoice, an invoice application form and a letter of transmittal by FAX by a printer (not shown) etc connected to the staff terminal 32.

The member of operation staff transfers the printed invoice and the printed invoice application form to, e.g., a person-in-charge at a finance division that actually conducts affairs of issuing (approving) the invoice, thus requesting the forwarding of the invoice to the consumer. The letter of transmittal by FAX is printed if previously requested to transmit the invoice by FAX (facsimile) and is transmitted by FAX to an addressee.

The receipt-related output file 28 contains receipt application form format data 281 and receipt application form data 282. The receipt application form format data 281 is printed as a receipt application form by the printer (unillustrated) etc connected to the staff terminal 32.

The member of operation staff transfers the printed receipt application form to, e.g., the person-in-charge at the finance division that actually conducts affairs of issuing (approving) the receipt, thus requesting the forwarding of the receipt to the consumer. The receipt application form data 282 is data contained in the receipt application form format data 281, then transferred to the finance division as electronic data together with the receipt application form, and utilized in a system etc at the finance division.

Incidentally, the details of the screen provided to the staff terminal 32 from the document issuance management application 22 will be explained in the paragraph of [Operational Example]. Moreover, the present invention does not limit the method of building up the document issuance management application 22. It is assumed in the present embodiment that the document issuance management application 22 is built up as a Web application.

Further, the present invention does not limit a method of giving, when the agent receives the receipt-and-invoice issuance request by phone separately from the order of the merchandise, notification of information about this issuance request to the operation staff of the manufacturer company of the merchandise. Electronic data containing a record of content related to the issuance request on the phone may be sent to another system server connected to the company intranet 2 of the manufacturer company of the merchandise.

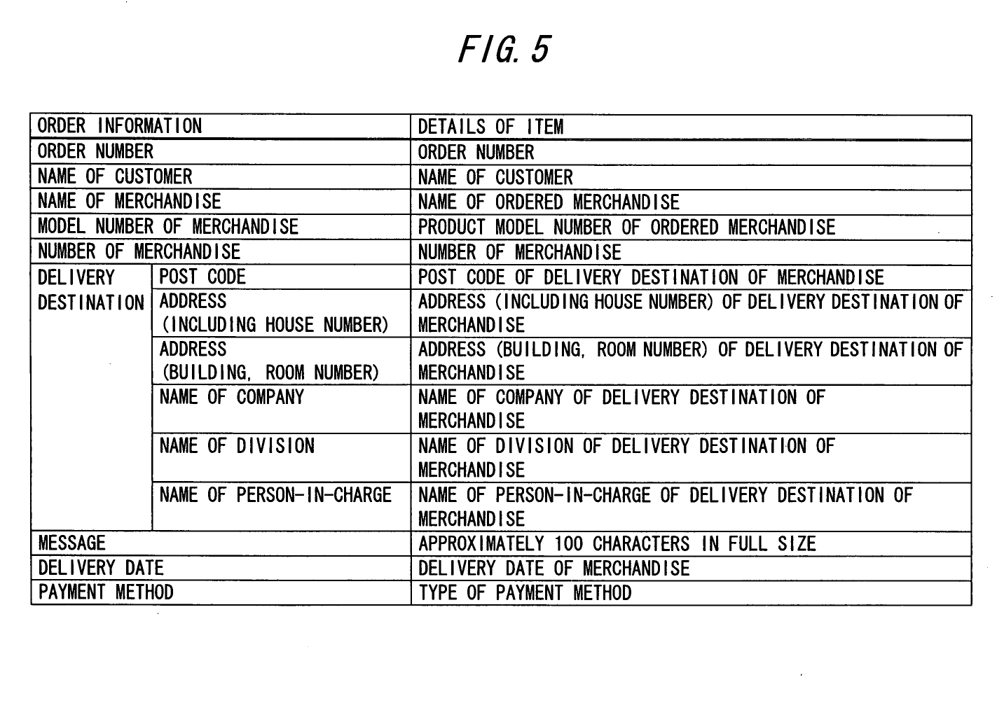

The order information management database 29 stores the order information and the issuance document request information that are collected by the order management application 21. Further, the order information management database 29 stores the information about the respective orders received from another company system. FIGS. 5, 6 and 7 are diagrams showing an order information table, a receipt information table and an invoice information table that structure the order information management database 29. Each of these tables is related by the order number.

The order information table shown in FIG. 5 stores the items of information within the order information interface file 18 collected by the order management application 21. Information stored in a delivery date field is the information that does not exist in the order information interface file 18, wherein a delivery date (delivering date) of the ordered merchandise, which is transmitted from another arrangement system (unillustrated) connected to the company intranet 2, is stored in this delivery date field.

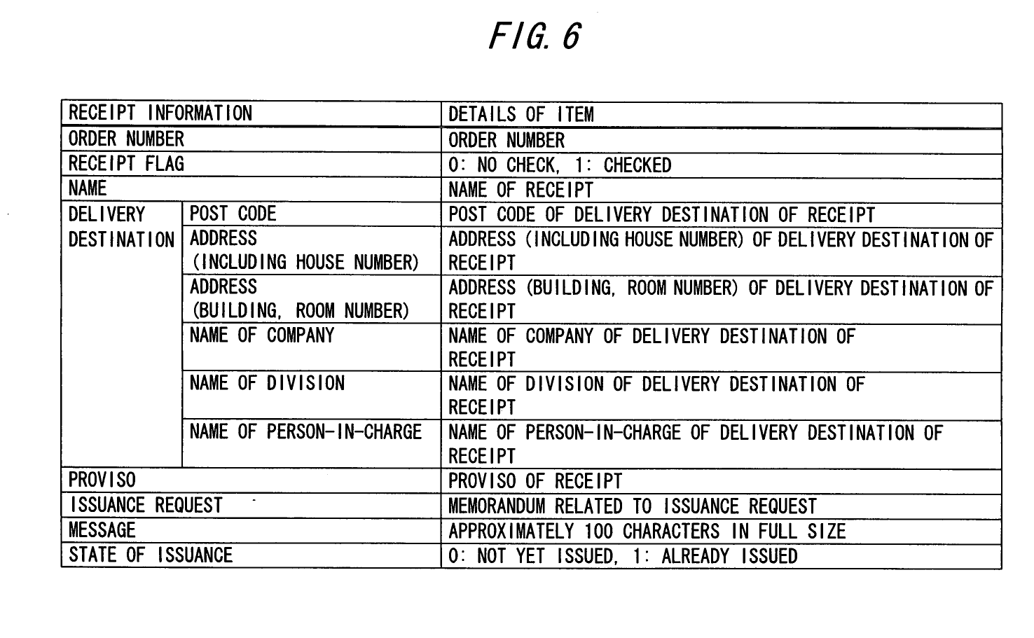

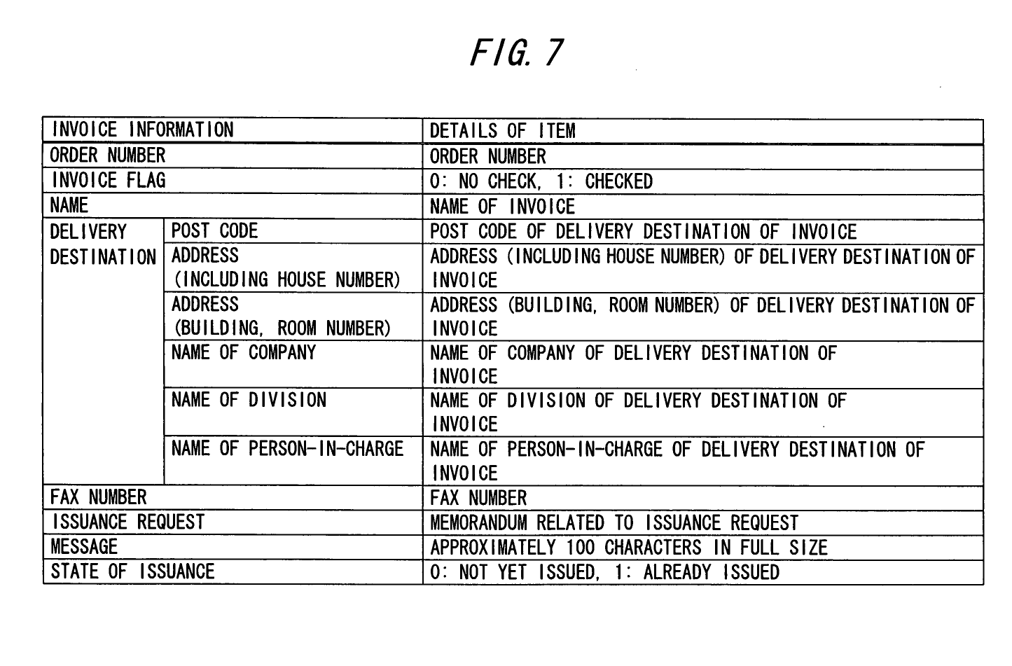

The information within the issuance document interface file 19 collected by the order management application 21 is stored in the receipt information table and in the invoice information table shown in FIGS. 6 and 7. An issuance request field stores a memorandum concerning the issuance request inputted when capturing the information from the issuance document interface file 19 or the order information interface file 18 or when the member of operation staff accepts the document issuance request. The memorandum having a content such as [the receipt issuance was requested on Aug. 10, 2006] is stored therein.

A state-of-issuance field stores information showing whether a receipt-or-invoice issuance process has already been executed or not. Note that the fields other than this state-of-issuance field have the same contents as those in the issuance document interface file 19 shown in FIG. 3.

<User Terminal, Agent Terminal and Staff Terminal>

The user terminal 31, the agent terminal 33 and the staff terminal 32 are client devices that access the order receiving server 10 or the order management server 20 described above. Each of these terminals may be constructed of a general-purpose computer such as a personal computer including, as a hardware configuration, a CPU, a memory and an input/output interface, and may also be constructed of a dedicated computer. The present invention does not limit this type of hardware configuration of each of these terminals.

The user terminal 31 may be sufficient if having a communication function capable of accessing the order receiving server 10 connected to the Internet 1 and a function (e.g., a Web Browser etc) capable of executing a function provided by the order receiving application 11 of the order receiving server 10.

The agent terminal 33 may be sufficient if having the communication function capable of connecting to the agent network 3 and the function (e.g., the Web Browser etc) capable of executing functions provided by the order receiving application 11 and the accepting application 12 of the order receiving server 10.

The staff terminal 32 may be sufficient if having the communication function capable of connecting to the company intranet 2 and functions (e.g., the Web Browser, a printing function, etc) capable of executing functions provided by the document issuance management application 22 of the order management server 20.

[Operational Example]

Next, an operational example of the document issuance system in the embodiment of the present invention will be explained. The document issuance system in the present embodiment is an integrated system of the system provided by the order receiving server 10 utilized by the agent and the system provided by the order management server 20 utilized by the operation staff of the manufacturer company of the merchandise.

<Operation of Online Shopping System Utilized by Consumers>

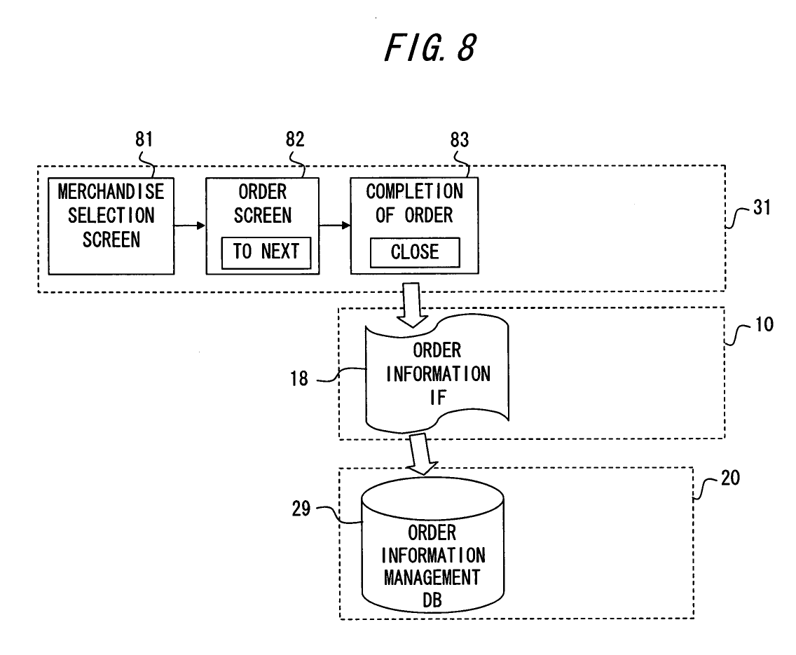

Before explaining the operational example of the document issuance system, to begin with, an operational example of the online shopping system will be described with reference to FIG. 8. FIG. 8 is a diagram showing a concept of a processing flow of the online shopping system. Incidentally, when the consumer accesses the integrated online shopping system, only the online shopping system is utilizable, and it may therefore be said that FIG. 8 is the diagram showing the processing flow when the consumer accesses the integrated online shopping system.

The consumer, on the occasion of purchasing a predetermined merchandise by the online shopping, accesses an online shopping Web site provided by the order receiving application 11 of the order receiving server 10 in a way that uses the Web Browser etc on the user terminal 31. The user terminal 31 is provided anytime with a predetermined screen (a Web page) from the order receiving application 11. When accessing the Web site, at first, a log-in screen (unillustrated) is displayed on the user terminal 31. The order receiving server 10 acquires user identifying information etc inputted from on this log-in screen 91, thereby recognizing that the accessing user is the consumer.

With this operation, the user terminal 31 is provided with only the online shopping service by the order receiving application 11. Specifically, a merchandise selection screen 81 illustrated in FIG. 8 is displayed on a display unit of the user terminal 31 via the Web Browser. The consumer selects a want-to-purchase merchandise by operating a menu and buttons on the screen in a way that uses a pointing device etc of the user terminal 31. Finally, the order is completed by confirming the merchandise to be purchased on an order screen 82, and an order completion screen 83 is displayed.

Upon becoming a completion-of-order status, the order receiving application 11 of the order receiving server 10 stores the information on this order in the order information interface file 18.

The order management server 20 collects the order information interface file 18 at a predetermined cycle. The order management server 20 stores the order information to be stored in the collected order information interface file 18 in the order information management database 29. The order information is further sent to another arrangement system etc, whereby the ordered merchandise is manufactured and then delivered to the customer.

<Operation of Document Issuance System Utilized by Agent>

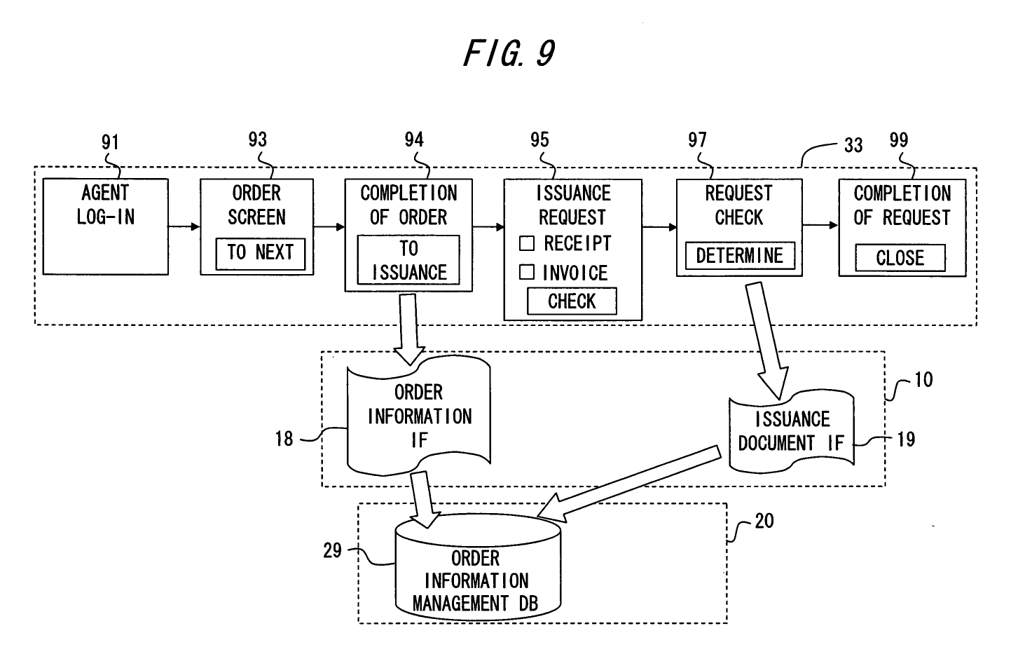

Next, an operational example in a case where the agent in charge of the purchase consulting counter, when receiving a merchandise purchase request by phone from the consumer, accesses the integrated online shopping system by use of the agent terminal 33, i.e., an operation example in a case where the online shopping system and the document issuance system operate in a way that links up with each other, will be explained with reference to FIG. 9. FIG. 9 is a diagram showing a concept of a processing flow of the online shopping system and of the document issuance system.

The agent, when receiving the purchase request of the predetermined merchandise by phone from the consumer, accesses the online shopping Web site provided by the order receiving application 11 of the order receiving server 10 in a way that operates the agent terminal 33. A log-in screen 91 is displayed on the display unit of the agent terminal 33 via the Web Browser. The order receiving server 10 acquires the user identifying information etc inputted from on the log-in screen 91, thereby recognizing that the access user is the agent.

Thereafter, screens (a merchandise selection screen (unillustrated), an order screen 93, etc) provided by the online shopping system are displayed on the agent terminal 33. The agent orders the merchandise requested on the phone by operating these screens. The agent checks the merchandise to be purchased on the order screen 93 and shifts to an order completion screen 94.

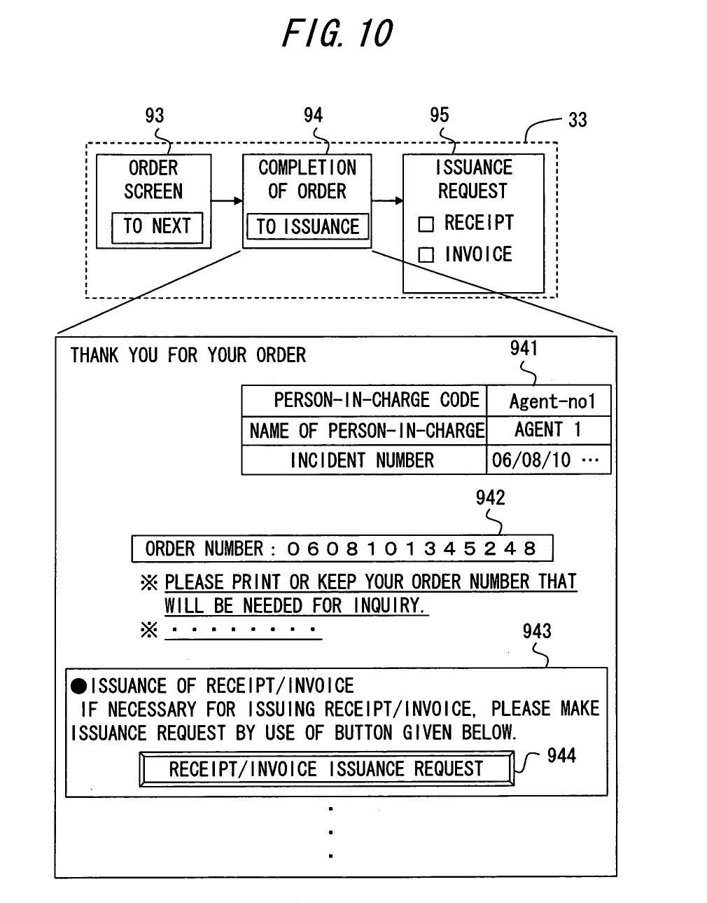

When the agent logs in the integrated online shopping system, the order completion screen 94 is displayed as in an example shown in FIG. 10. FIG. 10 is a diagram showing the example of the order completion screen 94. A log-in user information display area 941, an order number display area 942 and a document issuance system shift area 943 are displayed on the order completion screen 94. A person-in-charge code, a name of person-in-charge, etc are displayed in the log-in user information display area 941. The person-in-charge code is a user identifier (Agent-nol), and the order receiving server 10 judges based on this user identifier whether the log-in user is the agent or not. An order number of the order requested through the online shopping system is displayed in the order number display area 942. Note that even when the consumer logs in the integrated online shopping system, except a case that the document issuance system shift area 943 gets into a non-display status, the other display areas may be displayed, similarly.

The agent selects a receipt/invoice issuance request button 944 in the document issuance system shift area 943 on the order completion screen 94. With this selection, the agent can shift to the document issuance system from the online shopping system and can make the request for issuing the receipt and the invoice about the order given by the online shopping.

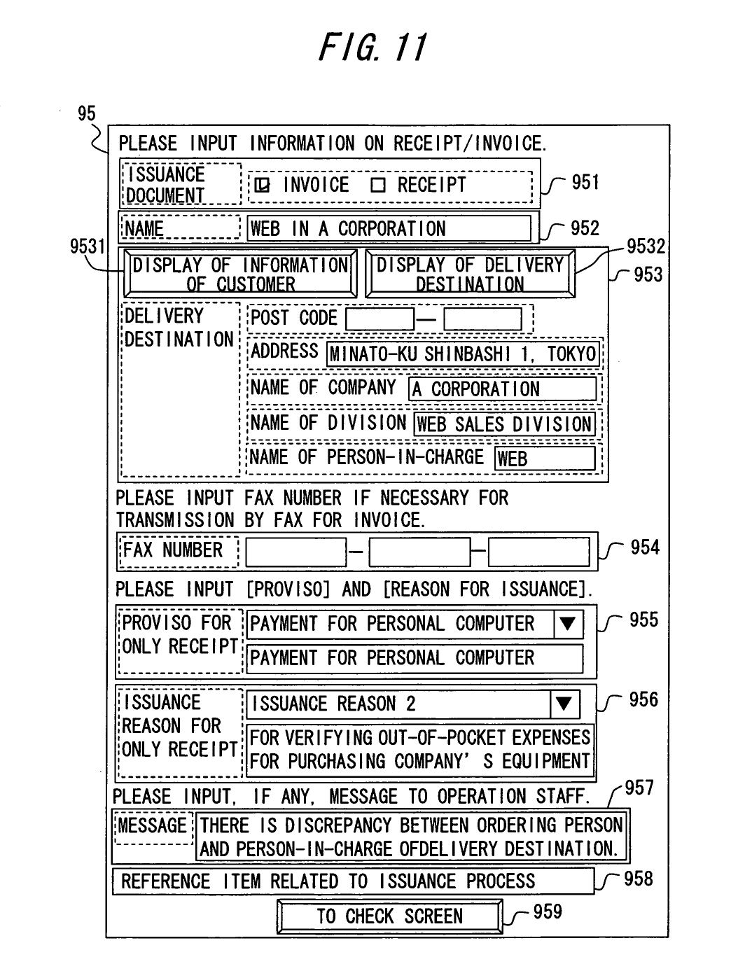

To start with, an issuance request screen 95 provided by the accepting application 12 of the order receiving server 10 is displayed on the agent terminal 33. At this time, the order receiving application 11 of the order receiving server 10 gets the information on this order stored in the order information interface file 18. FIG. 11 is a diagram showing an example of the issuance request screen 95. The issuance request screen 95 is organized by an issuance document selection area 951, an name input area 952, an delivery addressee input area 953, a FAX umber input area 954, a proviso input area 955, a reason-for-issuance input area 956, a message input area 957, a reference item display area 958, a shift button 959, etc.

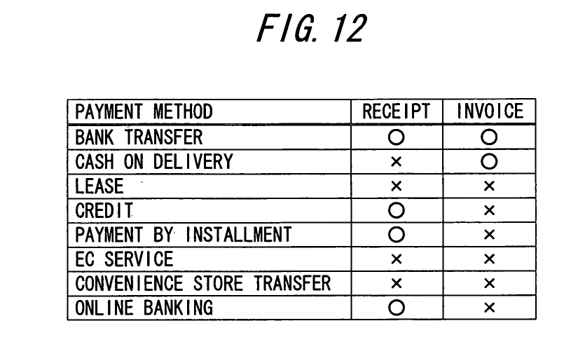

In the issuance document selection area 951, the issuance of at least one of the invoice and the receipt about the already-given order can be selected. The document issuance system (the accepting application 12) acquires the information on the order from the online shopping system, and performs display control of the issuance document selection area 951. FIG. 12 is a diagram showing a table serving for conducting the display control of the issuance request screen 95 in the document issuance system. The document issuance system acquires a [payment method] as the information on the order, and performs the display control of the issuance request screen 95 on the basis of the thus-acquired payment method and the display control table illustrated in FIG. 12. The document issuance system can select, based on this display control table, an issuable document with respect to each payment method.

The example shown in FIG. 12 is that the control is done to make both of the receipt and the invoice selectable when [bank transfer] is chosen as the payment method, to make only the invoice selectable when [cash on delivery] is chosen, and to make only the receipt selectable when [credit], [payment by installment] and [online banking] are chosen. Further, when [lease], [EC (Electronic Commerce)] and [transfer at convenience store] are selected, neither the receipt nor the invoice can be issued, and hence the control is done so that the issuance request screen 95 itself is not displayed.

Necessary items about the document selected in the issuance document selection area 951 are inputted to the following input areas and display areas. A name of the selected document is inputted to a name input area 952. An address of a delivery destination of the selected document is inputted to a delivery destination input area 953. When an customer information display button 9531 is selected, the address of the customer inputted on the online shopping is displayed in this delivery destination input area 953. When a delivery destination display button 9532 is selected, an address of the delivery destination of the order inputted on the online shopping is displayed in the delivery destination input area 953.

By the way, there might be a case in which the invoice is requested to be transmitted by FAX beforehand. Such being the case, the invoice is selected as the issuance document, and, if requested to be transmitted by FAX beforehand, a FAX number of the transmission destination is inputted to a FAX number input area 954.

A content, which should be written in a proviso column of the receipt, is inputted to a proviso input area 955. The content to be written can be selected from within those displayed in a pulldown menu provided above the proviso input area 955. Further, the content can be also inputted directly to an input area provided below the proviso input area 955. For example, [payment for personal computer], [payment for peripheral device], [payment for software], [nothing], etc are displayed in the pulldown menu.

A content, which should be written in a reason-for-issuance column of the receipt, is inputted to a reason-for-issuance input area 956. The content to be written can be selected from within those displayed in a pulldown menu provided above the reason-for-issuance input area 956. Further, the content can be also inputted directly to an input area provided below the reason-for-issuance input area 956. For instance, [demand of customer], [for verifying individual's out-of-pocket expenses for purchasing company's equipment], etc are displayed in the pulldown menu.

Messages given from the agent to the operation staff of the manufacturer company of the merchandise, who actually perform the operation of issuing the receipt and the invoice, are inputted to a message input area 957. Moreover, helpful information for the user employing the issuance request screen 95 is displayed in a reference item display area 958.

The agent, upon completion of inputting the necessary items, shifts to a request content check screen 97 by selecting a shift button 959. At this time, the document issuance system checks the contents inputted. If the receipt is not selected in the issuance document selection area 951 and if items of information are inputted to the proviso input area 955 and to the reason-for-issuance input area 956, for example, an alert such as [the proviso (reason for issuance) becomes the input item only when requesting the issuance of the receipt], is displayed on the issuance request screen 95. Similarly, if the invoice is not selected in the issuance document selection area 951 and if the information is inputted as the FAX number, for example, an alert such as [the FAX number becomes the input item only when requesting the issuance of the invoice], is displayed on the issuance request screen 95.

A list of contents inputted on the issuance request screen 95 is displayed on the request content check screen 97. The agent checks the request contents through on the request content check screen 97, and gets the request contents determined. With this operation, a request completion screen 99 is displayed, resulting in termination of the document issuance service. Further, when the request contents are determined, the document issuance system stores the determined request contents in the issuance document interface file 19. The issuance document interface file 19 is collected together with the order information interface file 18 by the order management server 20.

<Operation of Document Issuance System Utilized by Operation Staff>

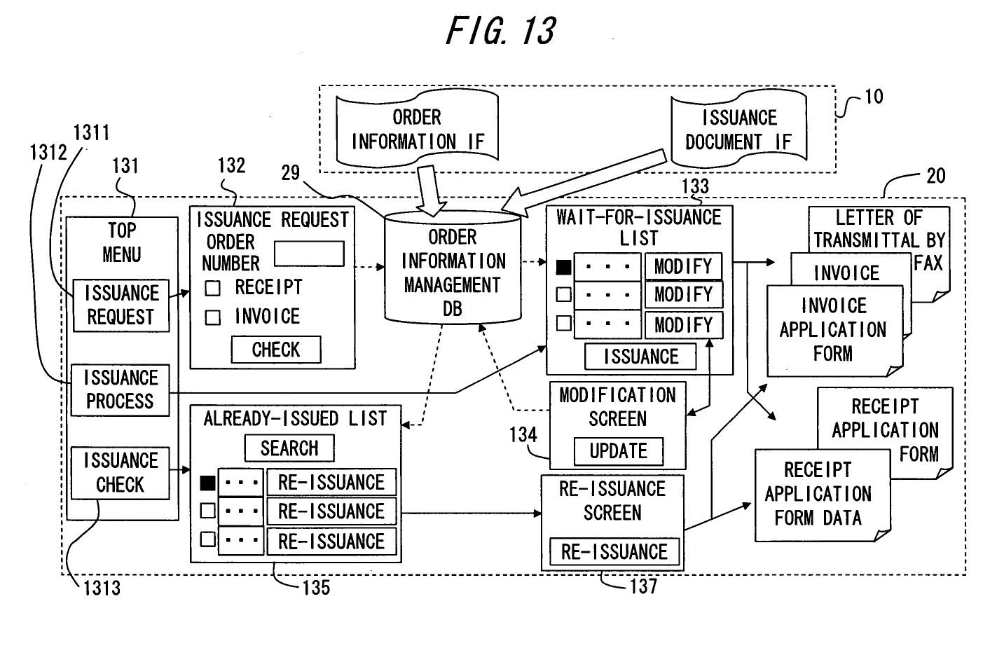

Next, an operation of the document issuance system in the present embodiment in a case where the operation staff of the manufacturer company of the merchandise utilize this system, will be explained with reference to FIG. 13. The operation staff does not utilize the online shopping system but utilize only the document issuance system provided by the document issuance management application 22 of the order management server 20. FIG. 13 is a diagram showing a concept of a processing flow of the document issuance system of the order management server 20.

A member of operation staff operates the staff terminal 32, thereby accessing a staff-oriented Web site provided by the document issuance management application 22 of the order management server 20 connected to the company intranet 2. A log-in screen (unillustrated) is displayed via the Web Browser on the display unit of the staff terminal 32. The order management server 20 acquires the user identifying information etc inputted from on this log-in screen, thereby recognizing that the access user is the operation staff member.

Thereafter, a top menu screen 131 provided by the order management server 20 is displayed on the staff terminal 32. The member of operation staff selects a menu corresponding to an operation of the staff member himself or herself from on this top menu screen 131. The member of operation staff, in the case of utilizing the first management service of the document issuance system, selects an issuance request menu 1311. This case includes a case in which the member of operation staff accepts the receipt-and-invoice issuance request by e-mail from the consumer who has already made the order on the online shopping and registers the issuance request, and a case in which the agent accepts the receipt-and-invoice issuance request by phone from the consumer, and the member of operation staff registers, when notified of the issuance request information, this issuance request.

The member of operation staff, in the case of utilizing the second management service of the document issuance system, i.e., in the case of managing a requested receipt-and-invoice issuance state, selects an issuance processing menu 1312.

The member of operation staff, in the case of utilizing the third management service of the document issuance system, i.e., in the case of reissuing the document which is to be modified about a requested content or has already been issued, selects an issuance check menu 1313.

<<Operation When Selecting Issuance Request Menu>>

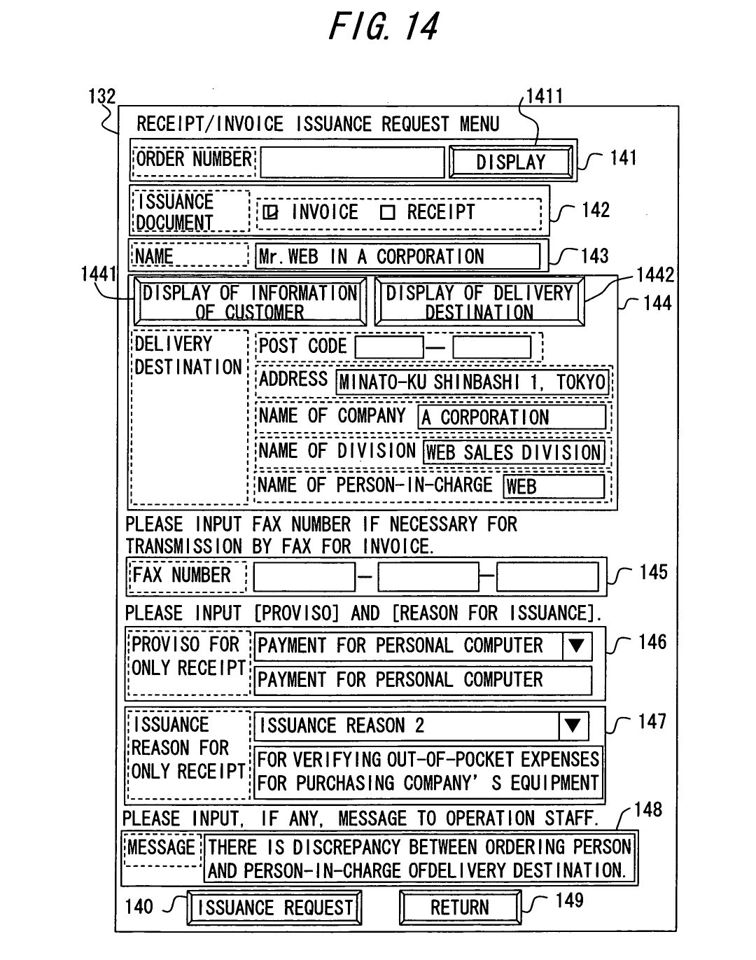

When the issuance request menu 1311 is selected, the issuance request screen 132 is displayed on the display unit of the staff terminal 32. FIG. 14 is a diagram illustrating an example of the issuance request screen 132 used by the operation staff. The issuance request screen 132 is organized by an order number input area 141, an issuance document selection area 142, a name input area 143, a delivery destination input area 144, a FAX number input area 145, a proviso input area 146, a reason-for-issuance input area 147, a message input area 148, an issuance request button 140, a return button 149, etc. Among these function elements, the display areas and the input areas other than the order number input area 141, the issuance request button 140 and the return button 149, are the same as those on the issuance request screen 95 provided by the accepting application 12 of the order receiving server 10 described above.

The document issuance management application 22 of the order management server 20 conducts the display control of the issuance request screen 132 on the basis of the order number inputted to the order number input area 141. The document issuance management application 22, when the order number is inputted and a display button 1411 is selected, searches the order information management database 29 on the basis of the inputted order number. The document issuance management application 22 searches the invoice information table, the receipt information table and the order information table in this sequence for a record associated with the order number. If the record concerned is retrieved from the invoice information table or the receipt information table, items of information contained in this record are displayed in the predetermined display areas and input areas on the issuance request screen 132. In the case of the already-issued document (when [1: already issued] is stored in a state-of-issuance field), however, the control is done so that this document is set unchangeable in the issuance document selection area 142. Note that when the member of operation staff accepts the document issuance request, normally the record associated with the order number exists in neither the invoice information table and nor the receipt information table.

The document issuance management application 22, if unable to obtain the invoice information and the receipt information, extracts the information about the order number from the order information table, and displays the extracted items of information as a default in the predetermined display areas and input areas on the issuance request screen 132. For instance, the items of information stored in the name-of-company field and in the person-in-charge field of the order information table are spaced and thus displayed in the name input area 143.

By the way, on the issuance request screen 95 utilized by the agent, the accepting application 12 of the order receiving server 10 performs the display control of the issuance document selection area 951 on the basis of the information about the payment method for the order. On the issuance request screen 132 utilized by this member of operation staff, the document issuance management application 22 performs none of the display control of the issuance document selection area 142. This intends to cope with a case of receiving the issuance request about even an originally issuance-disabled document by the selected payment method from the consumer as a special case. Only the operation staff can cope with such a special case, and hence this type of control can be done only on the issuance request screen 132 used by the operation staff. Thus, if selected for the issuance-disabled document by the selected payment method, the alert is displayed on the issuance request screen 132.

When the issuance request button 140 is selected, the information inputted to the issuance request screen 132 is stored in the order information management database 29. Further, when the return button 149 is selected, the issuance request screen 132 is terminated.

<<Operation When Selecting Issuance Processing Menu>>

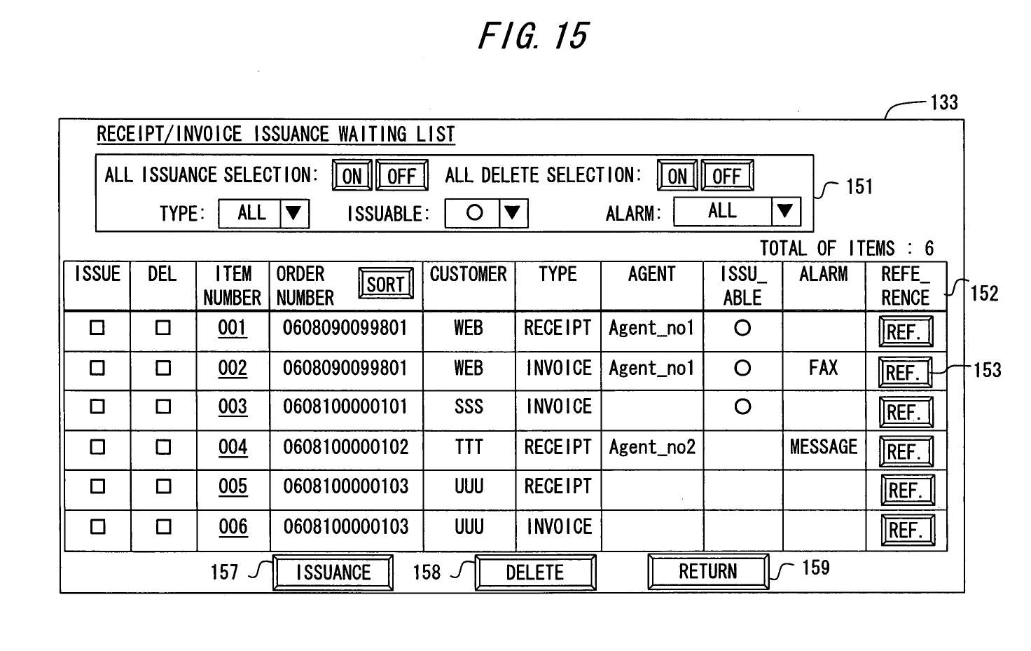

When an issuance processing menu 1312 is selected, a wait-for-issuance list screen 133 is displayed on the display unit of the staff terminal 32. FIG. 15 is a diagram showing an example of the wait-for-issuance list screen 133. The wait-for-issuance list screen 133 is displayed based on the data stored in the order information management database 29. The wait-for-issuance list screen 133 is organized by a list control area 151, a list display area 152, an issuance button 157, a delete button 158, a return button 159, etc.

Displayed in the list display area 152 are respectively an issuance flag, a delete flag, an item number, an order number, an customer, a type of document, a name of agent, issuable information and alarm information of each of the documents with the issuance requests registered. The document with the already-completed issuance process is not displayed in the list display area 152. Judgment as to whether the issuance process has been completed or not is made by referring to the state-of-issuance fields of the receipt information table and of the invoice information table.

The issuance flag is selected about the document that undergoes the issuance process. The document, about which the issuance flag is selected, undergoes the issuance process when selecting the issuance button 157. The delete flag is selected about the document subjected to a delete process. The document, about which the delete flag is selected, undergoes the delete process when selecting the delete button 158.

The receipt or the invoice is displayed in the column of the type of document. When the receipt-and-invoice issuance request about one order (single order number) is registered, the receipt and the invoice are respectively displayed in each row of the list display area 152.

If the document concerned is set in the issuable status, [O] is displayed in the column of the issuable information. In the case of the receipt, it is judged that the issuable status occurs when reaching a delivery date stored in the delivery date field in the order information table of the order information management database 29. In the case of the invoice, the order information is sent to another arrangement system, it is judged by this arrangement system that the issuable status occurs when notified (when notified of an assigned arrangement number) of a purport that the registration of the order is completed.

Displayed in the column of the alarm information are [FAX required] when the invoice is required to be transmitted by FAX (when the data is stored in the FAX number field in the invoice information table) and [message received] when the messages about the invoice or the receipt are inputted (when the data is stored in the message field in the invoice information table or in the receipt information table).

When a reference button 153 in each row is selected, the order information in the row specified by this button is displayed.

A numerical value representing each row is displayed in the column of the item number. When the numerical value is selected, a modification screen 134 for the document issuance request is displayed. Details of the modification screen 134 will be explained later on.

The list control area 151 has a function of narrowing down the lists displayed in the list display area 152 with predetermined conditions (the type of document, the issuance state and the alarm information), a function (issuance all selection: ON, OFF) of selecting the issuance flags in all of the rows or canceling the selection thereof with respect to the lists displayed in the list display area 152, and a function (delete all selection: ON, OFF) of selecting the delete flags in all of the rows or canceling the selection thereof with respect to the lists displayed in the list display area 152.

As for the document type used as the list narrowing-down condition, any one of “receipt”, “invoice” and “all” can be selected from the pulldown menu. Further, as for the state of issuance employed as the list narrowing-down condition, any one of “issuable [O]”, “not yet issued” and “all” can be selected from the pulldown menu. As for the alarm used as the list narrowing-down condition, any one of “alarmed”, “no alarm” and “all” can be selected from the pulldown menu.

The selection of the issuance button 157 leads to execution of the issuance process of the document specified by the row where the issuance flag is chosen through the function of the list control area 151 or an input of the individual. The invoice-related output file 27 is outputted as the electronic file to the staff terminal 32 when the issuance process of the invoice is executed, and the receipt-related output file 28 is outputted as the electronic file to the staff terminal 32 when the issuance process of the receipt is executed. The invoice-related output file 27 and the receipt-related output file 28 are as described above.

The member of operation staff transfers, based on these files, the printed invoice and the printed invoice application form to the person-in-charge at the finance division that actually conducts affairs of issuing (approving) the invoice, thus requesting the forwarding of the invoice to the consumer. The letter of transmittal by FAX is printed if previously requested to transmit the invoice by FAX (facsimile) and is transmitted by FAX to an addressee. Further, the member of operation staff transfers the printed receipt application form to the person-in-charge at the finance division that actually conducts affairs of issuing (approving) the receipt, thus requesting the forwarding of the receipt to the consumer. The receipt application form data 282 is transferred as the electronic data together with the receipt application form to the finance division and is utilized in the system etc at the finance division.

The selection of the delete button 158 leads to execution of the delete process about the row where the delete flag is chosen through the function of the list control area 151 or the input of the individual. The record concerned in the receipt information table or in the invoice information table is deleted by this delete process. When the return button 159 is selected, the wait-for-issuance list screen 133 is terminated.

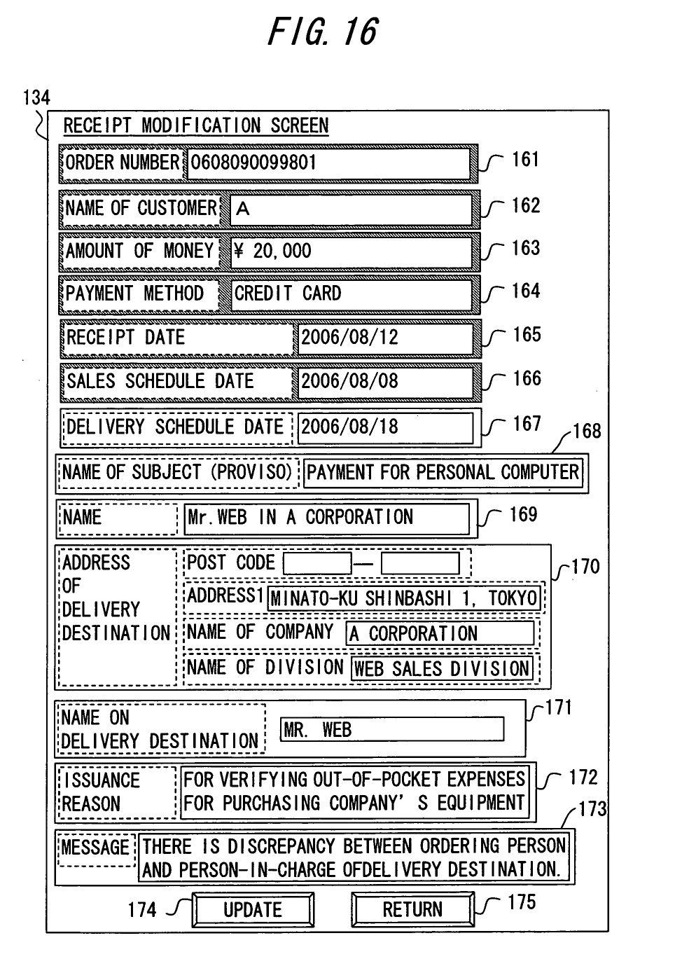

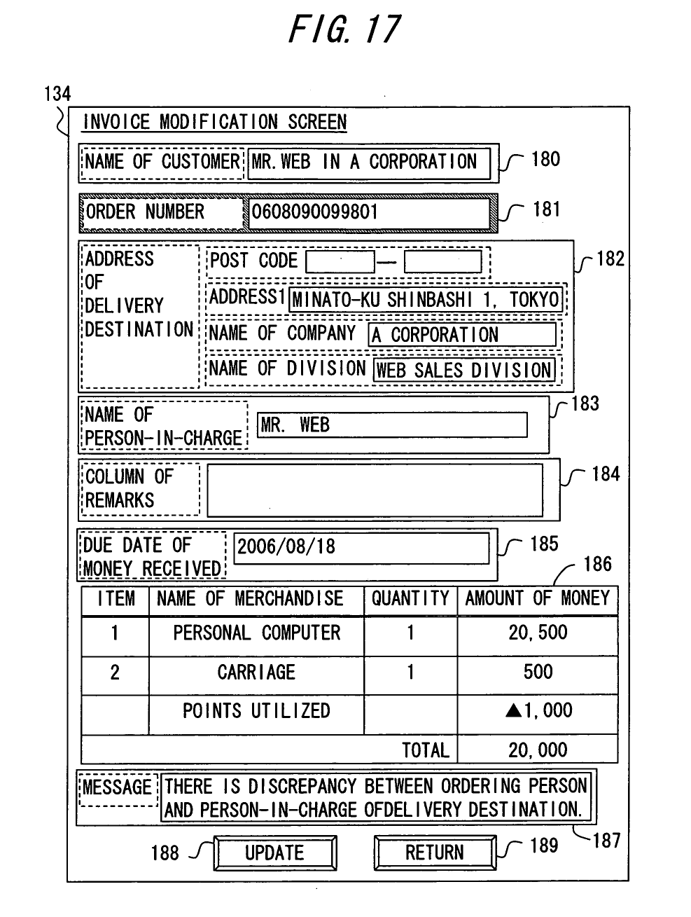

FIG. 16 is a diagram showing an example of a receipt modifying screen in the modification screen 134. FIG. 17 is a diagram showing an example of an invoice modifying screen in the modification screen 134. Any one of these modifying screens is displayed corresponding to the type of the document specified by each row. The member of operation staff, when receiving again a request for changing the information about the document requested after receiving the receipt-and-invoice issuance request, opens the modification screen 134.

The receipt modifying screen is organized by an order number display area 161, a name-of-customer display area 162, an amount-of-money display area 163, a payment method display area 164, a receipt date display area 165, a sales schedule date display area 166, a delivery schedule date display area 167, a name-of-subject display area 168, a name display area 169, a delivery destination address display area 170, a delivery destination name display area 171, a reason-for-issuance display area 172, a message display area 173, etc. Among these items, the order number, the name of customer, the amount of money, the payment method, the receipt date and the sales schedule date are the items of information about the order and are therefore so controlled as to be unchangeable. A date when receiving a charge through the selected payment method is displayed in the receipt date display area 165. A date when the sales are added up is displayed in the sales schedule date display area 166.

The items of information inputted on the issuance request screen 95 or 132 are displayed in other display areas. The member of operation staff can change the information displayed in the display areas other than the display areas that are so controlled as to be unchangeable. A date after 8 days from the date when the receipt modifying screen 134 was displayed, is displayed as the delivery schedule date.

The member of operation staff determines a change by selecting an update button 174. At this time, the order information management database 29 is updated with the information changed with respect to the receipt.

The invoice modifying screen is organized by a customer name display area 180, an order number display area 181, a delivery destination address display area 182, a name-of-person-in-charge display area 183, a remarks column display area 184, a money received due date display area 185, an ordered merchandise display area 186, a message display area 187, etc. Among these items, the order number displayed in the order number display area 181 and a content displayed in the ordered merchandise display area 186 are the information about the order and are therefore so controlled as to be unchangeable.

The items of information inputted on the issuance request screen 95 or 132 are displayed in other display areas. The member of operation staff can change the information displayed in the display areas other than the display areas that are so controlled as to be unchangeable. The member of operation staff can determine a change by selecting an update button 188. At this time, the order information management database 29 is updated with the information changed with respect to the invoice.

<<Operation When Selecting Issuance Check Menu>>

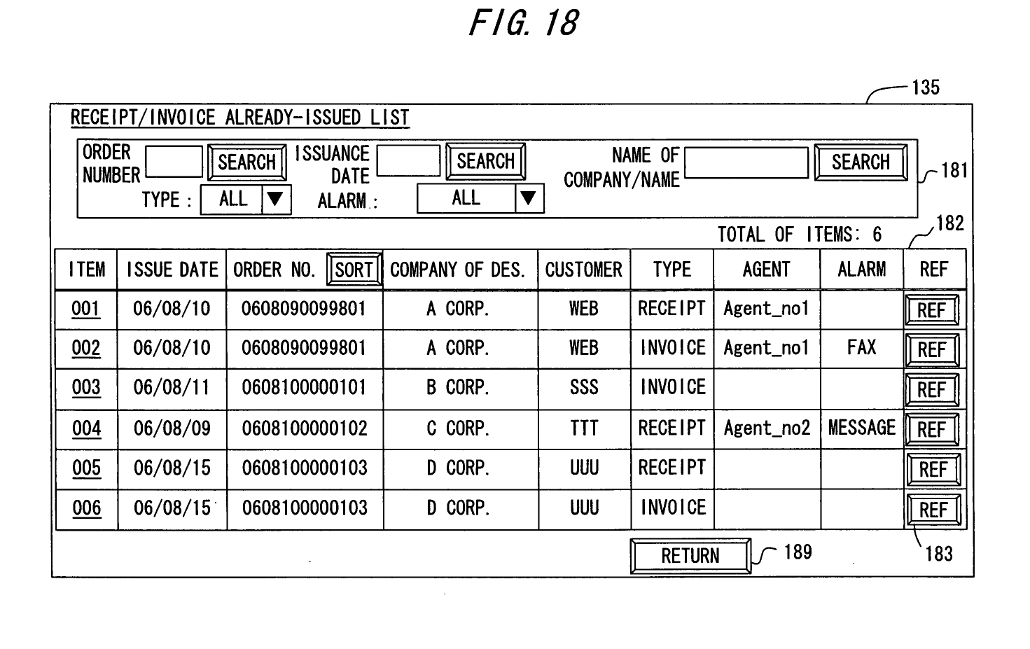

When an issuance check menu 1313 is selected, an already-issued list screen 135 is displayed on the display unit of the staff terminal 32. FIG. 18 is a diagram showing an example of the already-issued list screen 135. The already-issued list screen 135 is displayed based on the data stored in the order information management database 29. The already-issued list screen 135 is organized by a list control area 181, a list display area 182, a return button 189, etc. The already-issued list screen 135 has none of the function capable of issuing batchwise a plurality of documents as done on the wait-for-issuance list screen 133 described above. This is because the re-issuance itself of the receipt and the invoice is a special case and is a case with which the normal operation can not cope.

An item number, an order number, a name of delivery destination company, an customer, a type of document, a name of agent and alarm information with respect to each of the already-issued documents, are respectively displayed in the list display area 182. A not-yet-issued document is not displayed in the list display area 182. Judgment as to whether the issuance process is completed or not is made by referring to the state-of-issuance fields of the receipt information table and of the invoice information table. The respective items of information to be displayed are substantially the same as those on the wait-for-issuance list screen 133.

A date when executing the issuance process for the document is set in the issuance date. When a reference button 183 in each row is selected, the order information in this row is displayed.

Numerical values representing the respective rows are displayed in the column of the item number. When the numerical value is selected, a re-issuance screen 137 for the already-issued document is displayed. The re-issuance screen is substantially the same as the modification screen 134 except a point that the update button is replaced by a re-issuance button. When the re-issuance button is selected, the invoice-related output file 27 or the receipt-related output file 28 concerning the target document is outputted as the electronic file.

The list control area 181 has a function of narrowing down the lists displayed in the list display area 182 with predetermined conditions (the type of document and the alarm information), and a function of searching for the list displayed in the list display area 182 with predetermined conditions (the order number, the issuance date and the name of company or the name). The search function is executed by inputting the search conditions to the predetermined input areas and then selecting a search button. The list narrowing-down function is the same as on the wait-for-issuance list screen 133.

<Operation and Effect in Embodiment>

Herein, an operation and an effect of the document issuance system in the embodiment discussed above will be described.

The document issuance system in the present embodiment links up with the online shopping system utilized by the consumers and the agent, whereby the receipt-and-invoice issuance request information is managed in the form of being associated with the order information.

Namely, the order receiving server 10 connected to the Internet 1 outputs the order information interface file 18 related to the merchandise ordered in the online shopping system and the issuance document interface file 19 requested in the document issuance system, respectively. The order management server 20 utilized by the operation staff of the manufacturer company of the merchandise collects the order information interface file 18 and the issuance document interface file 19 respectively, which are then stored in the order information management database 29.

Further, the function provided by the order management server 20 works to similarly store the receipt-and-invoice issuance request, registered by the operation staff, of the already-ordered merchandise in the order information management database 29. Moreover, the order information management database 29 stores the information given from the arrangement system etc which manages the manufacturing information etc about the ordered merchandise in a way that associates this information with the order information.

In the document issuance system in the present embodiment, the receipt-and-invoice issuance states (an already-issued state, a not-yet-issued state, an issuable state, an issuance-disabled state, etc) are automatically generated by use of the order information, the document issuance request information and the arrangement information that are stored in the order information management database 29, and the wait-for-issuance list screen 133 displaying a list of issuance states is displayed.

With this operation, the operation staff utilizing the document issuance system in the present embodiment can grasp the receipt-and-invoice issuance states simply by referring to the wait-for-issuance list screen 133.

Outputted, further, from this wait-for-issuance list screen 133 are pieces of format data for the invoice, the invoice application form and the receipt application form each becoming the operation document for requesting the finance division etc that conducts the formal issuance operation of the receipt and the invoice. Moreover, if requested to deliver beforehand, a piece of format data for the letter of transmittal by FAX is outputted.

With this operation, the operation staff utilizing the document issuance system in the present embodiment grasp the receipt-and-invoice issuance states and are thereby capable of easily generating the operation documents for requesting another division etc with respect to the should-be-issued document.

Moreover, in the document issuance system in the present embodiment, on the issuance request screens 95 and 132, the FAX number can be inputted if required to previously transmit the invoice by FAX, and further the messages can be inputted if there are the messages given to the member of operation staff from another person-in-charge with respect to the issuance of the invoice and the receipt.

These items of input information are stored in the order information management database 29. Those special items are also displayed on the wait-for-issuance list screen 133 by employing the input information.

With this operation, the operation staff utilizing the document issuance system in the present embodiment can readily grasp the special circumstances concerning the receipt-and-invoice issuance request. More essentially, the operation staff can promptly cope with the special circumstances.

Moreover, the document issuance system in the present embodiment provides the distinction between the functions provided by the order receiving server 10 utilized by the agent etc and the functions provided by the order management server 20 utilized by the operation staff, corresponding to the operation of which the user employing this system is in charge. On the issuance request screen 95 provided by the order receiving server 10, the selectability of the issuance document is controlled depending on the payment method for the order, while on the issuance request screen 132 provided by the order management server 20, this control is not executed.

Accordingly, the agent etc can register the proper document issuance request simply by manipulating the issuance request screen 95 without recognizing the document issuable corresponding to the payment method. On the other hand, the member of operation staff capable of obtaining the variety of information about the merchandise can manipulate the issuance request screen 132 in a way that enables the special cases to be coped with.

Moreover, the member of operation staff is provided with the modification screen for the already-registered document issuance request and with the re-issuance screen etc for the already-issued document.

The contrivance enables the operation staff to flexibly cope with the special demands from the consumers.

<Modified Example>

In the embodiment discussed above, the order receiving server 10 utilized by the agent and the order management server 20 utilized by the operation staff are separately provided, however, these servers may also be configured by a single server. This case may involve managing the accessing users and limiting the functions provided corresponding to the users.

<Others>

The disclosures of Japanese patent application No. JP2006-241739, filed on Sep. 6, 2006 including the specification, drawings and abstract are incorporated herein by reference.

What is claimed is:

1. A document issuance system comprising:
an accepting unit accepting an issuance request related to at least one document of a receipt and an invoice inputted from a terminal;
a retaining unit retaining information about the issuance request accepted by the accepting unit as being related to order information of a merchandise that is the subject of the issuance-requested document;
a checking unit checking a state of issuance of each of the issuance-requested documents on the basis of the issuance request information and the order information that are retained by the retaining unit; and
a generating unit generating a list screen displaying the states of issuance of the issuance-requested documents, being checked by the checking unit, in the form of a list on a predetermined terminal.

2. A document issuance system according to claim 1, further comprising an output unit outputting each of data files enabling operation documents necessary for issuing each of the issuance-requested documents to be printed.

3. A document issuance system according to claim 2, wherein the generating unit excludes, from on the list screen, the document that has already been outputted by the output unit.

4. A document issuance system according to claim 1, wherein the accepting unit includes:
a request screen generating unit generating an issuance request screen on which the terminal inputs the issuance request; and
a request screen control unit controlling the issuance request screen generated by the request screen generating unit based on the order information of the merchandise that is the subject of the issuance-requested document, and displaying the controlled issuance request screen on the terminal.

5. A document issuance system according to claim 1, wherein the checking unit judges, if the issuance-requested document is the receipt, whether the receipt is issuable or not based on delivery date information of the merchandise that is contained in the order information.

6. A document issuance system according to claim 4, wherein the accepting unit further includes an identifying unit identifying a user using the terminal, and
the request screen control unit controls as to whether the issuance request screen can be displayed or not, corresponding to the user identified by the identifying unit.

7. A document issuance system according to claim 1, wherein the generating unit includes:
an identifying unit identifying a user using the predetermined terminal; and
a list screen control unit controlling as to whether the list screen can be displayed or not, corresponding to the user identified by the identifying unit.

8. A document issuance system according to claim 1, wherein the document issuance system is configured in the form of including an online shopping server opened on a public network and a manufacturer server administered by a manufacturer company of the merchandise ordered by the online shopping server,
the accepting unit is provided in each of online shopping server and the manufacturer server,
the retaining unit, the checking unit and the generating unit are provided in the manufacturer server, and
the order information contains information about the order acquired by the online shopping server.

9. A storage medium having stored therein a document issuance program executed on a computer, the document issuance program causing the computer to execute steps comprising:
an accepting step of accepting an issuance request related to at least one document of a receipt and an invoice inputted from a terminal;
a retaining step of retaining information about the issuance request accepted in the accepting step on retaining unit as being related to order information of a merchandise that is the subject of the issuance-requested document;
a checking step of checking a state of issuance of each of the issuance-requested documents on the basis of the issuance request information and the order information that are retained on the retaining unit; and
a generating step of generating a list screen displaying the states of issuance of the issuance-requested documents, being checked in the checking step, in the form of a list on a predetermined terminal.

10. A document issuance method comprising:
an accepting step of accepting an issuance request related to at least one document of a receipt and an invoice inputted from a terminal;
a retaining step of retaining information about the issuance request accepted in the accepting step on retaining unit as being related to order information of a merchandise that is the subject of the issuance-requested document;
a checking step of checking a state of issuance of each of the issuance-requested documents on the basis of the issuance request information and the order information that are retained on the retaining unit; and
a generating step of generating a list screen displaying the states of issuance of the issuance-requested documents, being checked in the checking step, in the form of a list on a predetermined terminal.

11. A storage medium having stored therein the document issuance program according to claim 9, wherein the document issuance program further causes the computer to execute
an output step of outputting each of data files enabling operation documents necessary for issuing each of the issuance-requested documents to be printed.

12. A storage medium having stored therein the document issuance program according to claim 9, wherein the accepting step includes:
a request screen generating step of generating an issuance request screen on which the terminal inputs the issuance request; and
a request screen control step of controlling the issuance request screen generated in the request screen generating step based on the order information of the merchandise that is the subject of the issuance-requested document, and displaying the controlled issuance request screen on the terminal.

13. A storage medium having stored therein the document issuance program according to claim 12, wherein the accepting step further includes an identifying step of identifying a user using the terminal, and
the request screen control step includes controlling as to whether the issuance request screen can be displayed or not, corresponding to the user identified in the identifying step.

14. A storage medium having stored therein the document issuance program according to claim 9, wherein the generating step includes:
an identifying step of identifying a user using the predetermined terminal; and
a list screen control step of controlling as to whether the list screen can be displayed or not, corresponding to the user identified in the identifying step.

15. A storage medium having stored therein the document issuance program according to claim 9, wherein the document issuance program is structured in the form of including a first program executed by an online shopping server opened on a public network and a second program executed by a manufacturer server administered by a manufacturer company of the merchandise ordered by the online shopping server,
the accepting step is included in the first program and the second program,
the retaining step, the checking step and the generating step are included in the second program, and
the order information contains information about the order acquired by executing the first program.
